(19) United States
(12) Patent Application Publication
(10) Pub. No.: US 2021/0269249 A1
(43) Pub. Date: Sep. 2, 2021

(54) BALL LIFTING DEVICE

(71) Applicants: Byoungkoo CHO, Yeoju-si (KR); Yeonuk JEONG, Seoul (KR); Bosub KIM, Daegu (KR); Chang suk HAN, Daegu (KR)

(72) Inventors: Byoungkoo CHO, Yeoju-si (KR); Yeonuk JEONG, Seoul (KR); Bosub KIM, Daegu (KR); Chang suk HAN, Daegu (KR)

(21) Appl. No.: 17/258,843

(22) PCT Filed: Jul. 8, 2019
(86) PCT No.: PCT/KR2019/008347

§ 371 Date: Jan. 8, 2021

(30) Foreign Application Priority Data
Jul. 9, 2018 (KR) 10-2018-0079225

(51) Int. Cl. B65G 33/04; A63B 47/00; A63B 41/08; A63B 71/02

(52) U.S. Cl. CPC B65G 33/04; A63B 47/002; A63B 41/08; B65G 2812/0527; A63B 2243/0037; A63B 2243/0095; A63B 71/023

(57) ABSTRACT

A ball lifting device of the present disclosure, which employs a spiral ball transporting method for smoothly moving a ball, can move along a free path, is easy to be installed and operated, and has excellent durability and strength. The ball lifting device can be installed indoors as well as outdoors for educational, entertainment or viewing purposes. The ball lifting device can quickly move inflated balls filled with air used in ball games, and can be installed in connection with sports facilities as an automatic ball supply system.

### CROSS-REFERENCE TO RELATED APPLICATION(S)

This application claims the benefit of International Patent Application No. PCT/KR2019/008347 filed on Jul. 8, 2019, claiming the priority of Korean Patent Application No. 10-2018-0079225 filed on Jul. 9, 2018, the disclosure of which is incorporated herein by reference in its entirety.

### BACKGROUND OF THE INVENTION

### (a) Field of the Invention

The present disclosure relates to a ball lifting device. More particular, the present disclosure relates to a ball lifting device that enables the ball to smoothly lift along a spiral guide and can be used in connection with the ball supply system for a ball game.

### (b) Description of the Related Art

A ball lifting device for using a ball used in sport events such as golf or bowling for educational, entertainment, or amusement purposes is known.

For example, Korean Registered Utility Model No. 20-0435097 discloses a technology for moving upward a golf ball up to an automatic golf ball tee-up portion using a vertically inclined ball transferring small screw. However, this design does not specifically disclose the structure of the screw, and there is a risk that a small ball falls out of the gap between the screws. Further, this design makes it easy to move a ball of solid material, for example, metal, stone, plastic material, etc., but is not suitable for moving balls made by injecting gas into rubber or leather.

U.S. Pat. No. 5,076,582 discloses a device that lifts a bowling ball along a track using the frictional force of a conveyor belt, wherein the conveyor belt is driven by pulleys.

However, among the above-mentioned prior patents, a device for stably and smoothly lifting a ball filled with air, in particular, a device for quickly lifting and supplying a ball for sports purposes, has not yet been commercialized.

### SUMMARY OF THE INVENTION

### Technical Problem

Therefore, the present disclosure aims to provide a ball lifting device that stably lifts a ball filled with air, can see the movement and trajectory of the ball, and is easy to be installed and operated.

### Technical Solution

In order to achieve the above object, the present disclosure provides a ball lifting device characterized in that a shaft is provided vertically long by connecting a central portion between a lower platform on the ground and an upper platform in the air, a plurality of vertical posts spaced apart around a shaft as the center are provided between the upper and lower platforms, a spiral guide is provided to extend up and down between vertical posts around the shaft as the central axis, the shaft is connected to the spiral guide by a connecting rod, and thus, when the shaft rotates, the spiral guide also rotates and at the same time, the ball lifts.

A support post may be further provided between the shaft and the vertical post to support the ball so that it can be stably lifted without going out.

On the underside of the upper platform, an outlet is provided in a place where the ball is finally located, and the outlet may include a pair of rails, and a hook portion extending between the rails in a concave shape so that the ball is seated without bouncing at the entrance of the rail.

A connecting rod is provided at each predetermined point of the spiral guide to fix the spiral guide and the shaft.

Also, the present disclosure provides a ball lifting device characterized in that a guide gear is provided in a longitudinal direction adjacent to or in connection with a vertical post or a support post, and the guide gear includes a protrusion that is continuously formed by being protruded on the side face so as to reduce a frictional force on the ball.

The guide gear may be made of a plastic material. In addition, the present disclosure provides a ball rolling system including: a ball lifting device, and a ball rolling section in which rails are continuously provided on the ball lifting device.

Further, the present disclosure provides a ball lifting device characterized in that a shaft is provided vertically long by connecting a central part between the lower platform on the ground and the upper platform in the air, a plurality of vertical posts spaced apart around the shaft as the center are provided to extend long between the upper and lower platforms, a spiral guide is provided to extend up and down between vertical posts around the shaft as the central axis, the shaft is connected to the spiral guide by a connecting rod, a guide rail is provided in the longitudinal direction integrally with the vertical post by continuously contacting the vertical post, the guide rail includes a protrusion that is continuously formed by being protruded on the side place so as to give a friction force to the ball, the ball is a type of material that is filled with air and inflated, and includes rubber or leather, and the ball lifts by contacting the protrusion of the guide rail without contacting the vertical post by rotation of the shaft.

In addition the present disclosure provides a ball lifting device characterized in that a shaft is provided vertically long by connecting a central portion between a lower platform on the ground and an upper platform in the air, a plurality of vertical posts spaced apart around a shaft as the center are provided to extend long between the upper and lower platforms, a spiral guide is provided to extend up and down between vertical posts around the shaft as the central axis, the shaft is connected to the spiral guide by a connecting rod, a guide frame is provided in the length direction integrally with the vertical post by continuously contacting the vertical post, and rotating rollers are continuously provided inside the frame in the length direction, the ball contains a rubber or a leather as a type of material that is filled with air and inflated, the ball does not come into contact with the vertical post due to the rotation of the shaft but slides and moves by being in contact with the roller.

### Advantageous Effects

The present disclosure can provide a ball lifting device that lifts a ball smoothly and quickly, can impart an appropriate movement to the ball, can be easily installed in an appropriate place, and has excellent strength and durability.

The present disclosure exerts the effect that the air-filled ball can be lifted and moved up and down quickly and smoothly.

### BRIEF DESCRIPTION OF THE DRAWINGS

FIG. 1 is an overall perspective view of a ball rolling system including a ball lifting device of the present disclosure;

FIG. 2 is an enlarged perspective view of the lower portion of the ball lifting device of FIG. 1;

FIG. 3 is a perspective view of a ball lifting device according to a second embodiment of the present disclosure;

FIG. 4 is a perspective view of a ball lifting device according to a third embodiment of the present disclosure;

FIG. 5 is another perspective view of a ball lifting device according to a third embodiment of the present disclosure;

FIG. 6 is a partial view showing a portion in which a guide frame is provided adjacent to a vertical post and rollers are continuously provided inside the guide frame in a height direction; and

FIG. 7 is a photograph embodying FIG. 6.

### DETAILED DESCRIPTION OF THE EMBODIMENTS

Hereinafter, some embodiments of the present disclosure will be described with reference to the accompanying exemplary drawings. In the following description, it should be noted that the same elements will be designated by the same reference numerals although they are shown in different drawings. Further, in the following description of the present disclosure, when is determined that a detailed description of the related known configuration or function make the subject matter of the present disclosure rather unclear, the detailed description thereof will be omitted.

Also, in describing the components of the present disclosure, symbols such as the first, second, i), ii), a), and b) can be used. These are solely for the purpose of differentiating one component from the other but not to imply or suggest the substances, order or sequence of the components. Further, throughout the specification, when a part is referred to as “including” or “comprising” a certain component, it means that it can further include other components, without excluding the other components, unless otherwise stated. If a component is described as ‘connected’, ‘provided’, or ‘attached’ to another component, it may mean the components are not only directly ‘connected’, ‘provided’, or ‘attached’ but also are indirectly ‘connected’, ‘coupled’, or ‘linked’ via a third component, and it should be construed in the broadest possible meaning.

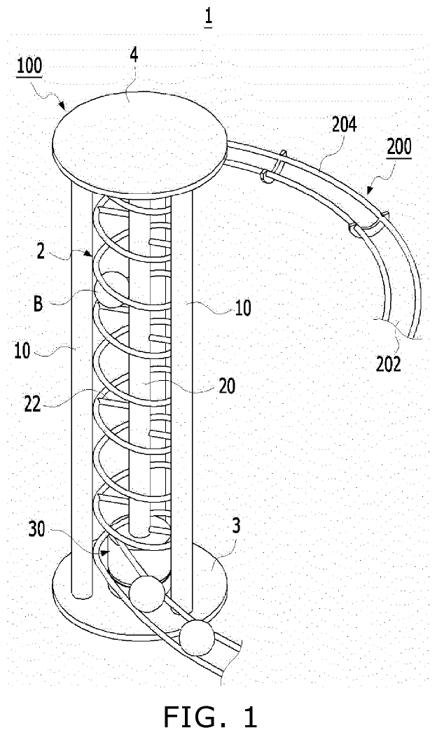

FIG. 1 is an overall perspective view of a ball rolling system 1 including a ball lifting device 100 of the present disclosure. The ball rolling system 1 includes a ball lifting device 100 and a ball rolling section 200 continuously provided thereto. The ball rolling system 1 can be installed in a school, a science exhibition hall, an outdoor camp for science, or the like for educational or amusement purposes. In particular, the ball rolling system 1 of the present disclosure can be utilized for the use which automatically supplies a ball of a ball game event to a player in cooperation with a sports facility.

The ball lifting device 100 is a device that vertically lifts the ball B from the ground to a position in the air, and has a structure in which a shaft 20 is provided vertically long by connecting a central portion between a lower platform 3 on the ground and an upper platform 4 in the air, a pair of vertical posts 10 spaced apart around a shaft 20d as the center are provided between the upper and lower platforms 3 and 4, and a spiral guide 2 is passed up and down between the vertical posts 10 with the shaft 20 being as the central axis, and the ball B is seated at a point on a spiral guide 2.

The shaft 20 is connected to the spiral guide 2 by a connecting rod 22, and thus, when the shaft 20 rotates, the spiral guide 2 also rotates. The ball B is turned according to the rotation of the spiral guide 2, and is stably lifted by a friction with the vertical post 10.

The ball B arriving at the upper end of the spiral guide 2 draws a free trajectory while passing along a rail 204 of the ball rolling section 200 and is discharged to the ground through the outlet 202.

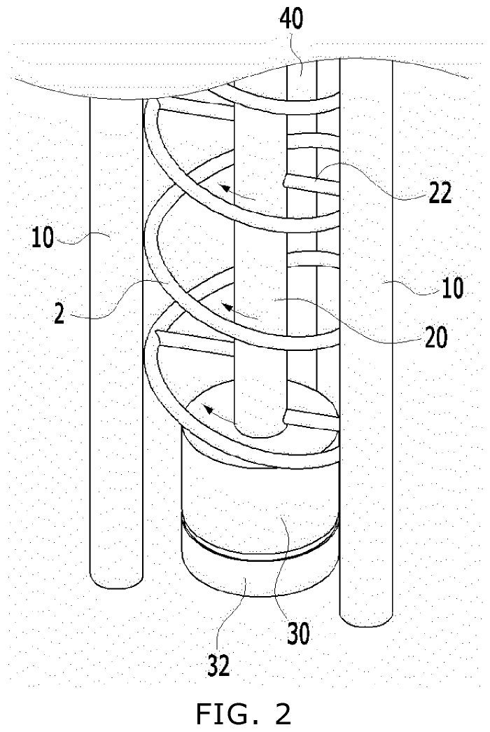

FIG. 2 is an enlarged perspective view of the lower portion of the ball lifting device of the present disclosure.

A circular stand 32 is provided at the central bottom of the lower platform 3. The lower end of the shaft 20 penetrating the stand 32 is connected to a drive source (not shown), for example, a motor, and the shaft 20 is rotated by the rotation of the motor. The upper end of the shaft 20 is inserted into a housing groove formed in the center of the upper platform 4. Therefore, although the shaft 20 has a long rod shape, both ends thereof are supported by the upper and lower platforms 4, so that a stable and long-term rotational movement can be performed. The position where the drive source is provided is not limited, for example, the drive source is provided on the upper platform 4 instead of the ground.

The spiral guide 2 is composed of a plurality of turns in a shape that inclines as it goes upward, and the diameter and pitch can be appropriately selected according to the size of the ball B. Since the spiral guide 2 is connected to the shaft 20 by the connecting rod 22 as described above, so that the spiral guide 2 rotates structurally integrally with the shaft 20. The connecting rods 22 may be provided at regular intervals, for example, every 3 pitches or every pitch, but the shape or number thereof does not limit the scope of the present disclosure as long as they perform the function of structurally integrating.

The lower portion of the spiral guide 2 adjacent to the lower platform 3 is connected to an introduction rail serving as a ball guide (not shown), which can automatically and continuously accommodate the balls.

The spiral guide 2 may be provided so as to rotate adjacent to the vertical post 10 as a whole.

The spiral guide 2 may be provided in a double spiral structure to lift two types of balls with different pitches, for example basketball and volleyball.

Although the spiral guide 2 is disclosed in the form of a line, it can be provided by changing in the form of the surface.

The support post 40 is provided between the shaft 20 and the vertical post 10, and serves to support the ball B so that it can be stably lifted without going out. A plurality of the support posts 40 may be provided.

The ball lifting device 100 of the present disclosure may be provided in connection with a sports facility. In this case, the ball rolling section 200 is connected to a ball supply device (not shown), and the outlet of the ball supply device may be provided at a position that supplies the ball to an athlete during exercise, for example, thereby establishing a system that automatically supplies the ball in sequence.

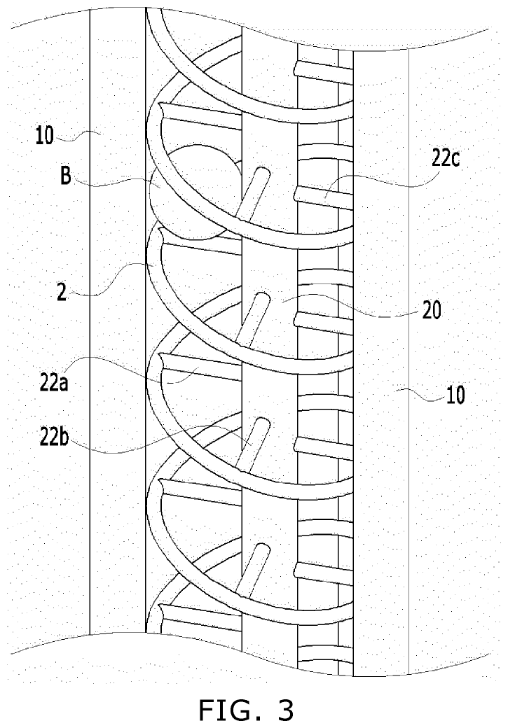

FIG. 3 is a perspective view of a ball lifting device 100 according to a second embodiment of the present disclosure.

The difference from the first embodiment is that the support post 40 is eliminated, the spiral guide 2 is thinly formed, and three connecting rods 22a, 22b and 22c are provided at predetermined points at uniform intervals. The ball B can be seated on the connecting rods 22a, 22b, 22c even in the absence of the support post 40, and lifts in conjunction with the rotation of the shaft 20 and the connecting rods 22a, 22b, 22c. Thus, it can be seen that it moves more dynamically than the first embodiment.

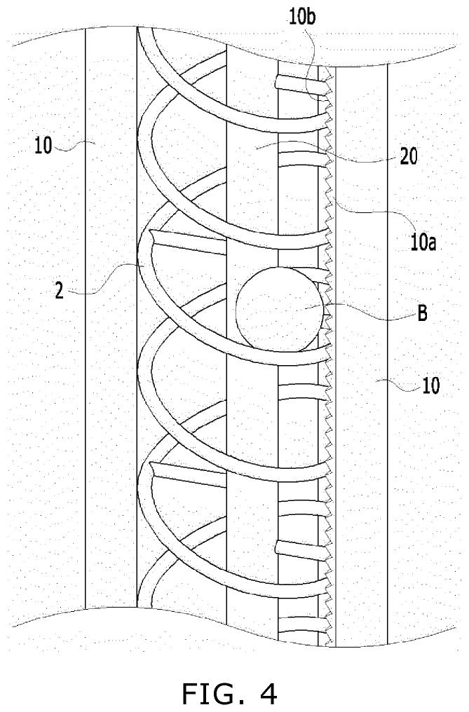

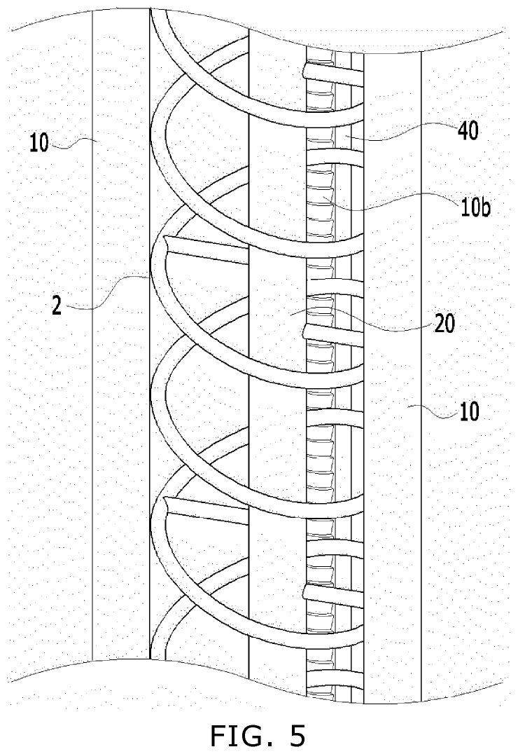

Next, a third embodiment of the present disclosure will be described with reference to FIGS. 4 and 5. The third embodiment is a type in which the ball B is inflated by being filled with air like volleyball or basketball. When the surface of the ball B comes into contact with a vertical post 10 or a support post 40 made of a metal material, the post receives a friction if the surface of the ball is a leather or a rubber, and thus, the ball may be crushed and separated off.

Therefore, in the third embodiment of the present disclosure, a guide rail 10a is provided adjacent to the vertical post 10 in the longitudinal direction as shown in FIG. 4. The guide rail 10a includes protrusions or a concavo-convex gear 10b that is continuously formed by being protruded on the side face. The guide rail 10a is made of a material, for example, a plastic, which can reduce the friction force when it comes into contact with the ball B. The ball B receives a frictional force that comes into contact with the gear 10b of the guide rail 10a without coming into direct contact with the vertical post 10, whereby the ball B can be quickly and smoothly lifted by the rotation of the shaft connected to the motor.

In FIG. 5, the support post 40 is provided with a guide rail 10a including a gear 10b, unlike FIG. 4. The functions and operations in this case are the same as those described in FIG. 4.

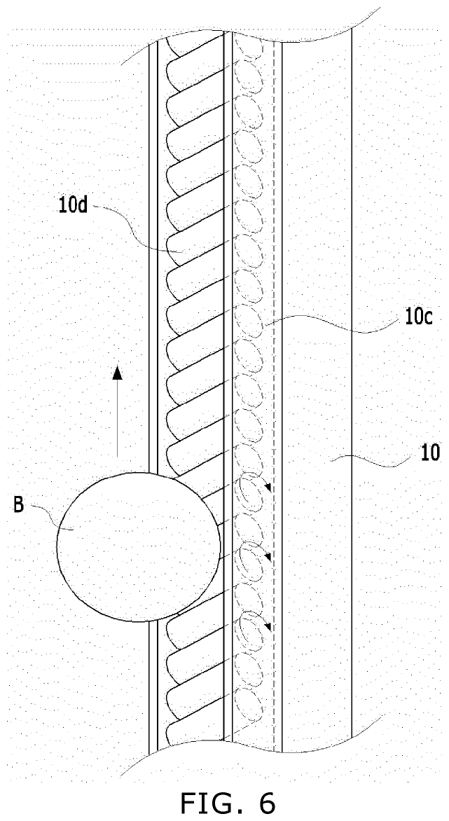

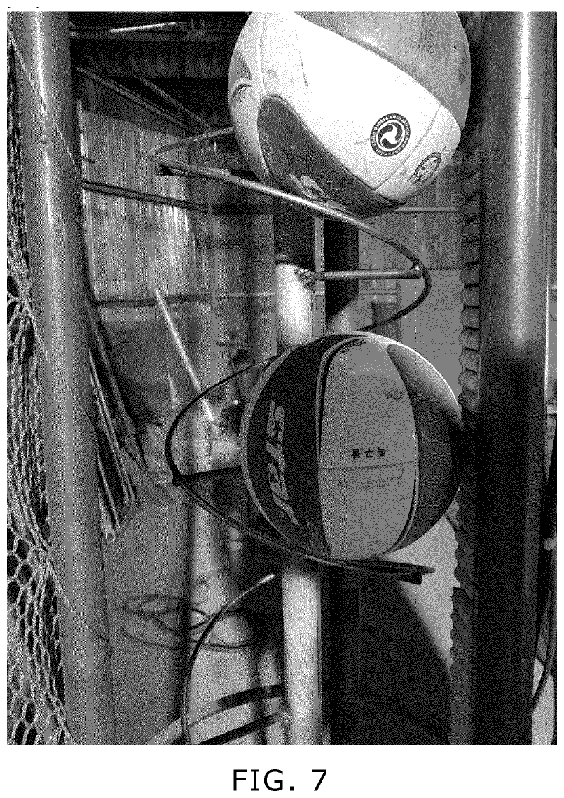

FIG. 6 shows an embodiment in which a guide frame 10c is provided in the longitudinal direction adjacent to the vertical post 10, and the rollers 10d are continuously provided in the height direction inside the guide frame 10c. FIG. 7 is a photograph of the ball lifting device for implementing FIG. 6. In this case, the ball B comes into contact with a roller 10d without coming into direct contact with the vertical post 10, so that the ball B slides up and moves along the roller 10d while the roller 10d rotates due to the frictional force of the ball. As a result, it can be expected that the ball is lifted more smoothly and stably as compared with FIG.

Unlike the above, the guide rail 10a does not necessarily have to be integrally connected to the vertical post 10 or the support post 40. Various modifications, such as manufacturing the vertical post 10 or the support post 40 itself as a guide rail 10a, can be made.

When the ball lifting device 100 of the present disclosure is used, it was confirmed that not only the ball can be lifted smoothly and quickly, but also the ball can be given an appropriate movement, the device can be easily installed in an appropriate place, and the strength and durability of the device are also excellent.

Although the preferred embodiments of the present disclosure have been described above, various modifications can be made to the present disclosure, and the scope of the present disclosure extends to the same or equivalent scope as the claims described below.

### INDUSTRIAL AVAILABILITY

The present disclosure can be used in sports industries such as physical education and leisure.

What is claimed is:

1. A ball lifting device characterized in that:
a shaft is provided vertically long by connecting a central portion between a lower platform on the ground and an upper platform in the air, a plurality of vertical posts spaced apart around a shaft as the center are provided to extend long between the upper and lower platforms, a spiral guide is provided to extend up and down between vertical posts around the shaft as the central axis, and the shaft is connected to the spiral guide by a connecting rod, a guide rail is provided in the length direction integrally with the vertical post by continuously contacting the vertical post, and rotating rollers are continuously provided inside the guide in the length direction.
the ball contains a rubber or a leather as a type of material that is filled with air and inflated,
the ball does not come into contact with the vertical post due to the rotation of the shaft but slides and moves when it comes into contact with the roller, and
the ball does not come into contact with the vertical post due to the rotation of the shaft but is lifted by contacting the protrusion of the guide rail.

2. The ball lifting device according to claim 1, wherein the spiral guide is composed of a plurality of turns in a shape that inclines upward as it goes upward.

3. The ball lifting device according to claim 2, wherein a support post is further provided between the shaft and the vertical post to support the ball so that it can be stably lifted without going out.

4. The ball lifting device according to claim 3, wherein the guide rail is further provided by continuously contacting the support post.

5. A ball lifting device characterized in that:
a shaft is provided vertically long by connecting a central portion between a lower platform on the ground and an upper platform in the air, a plurality of vertical posts spaced apart around a shaft as the center are provided to extend long between the upper and lower platforms, a spiral guide is provided to extend up and down between vertical posts around the shaft as the central axis,
a guide frame is provided in the length direction integrally with the vertical post by continuously contacting the vertical post, and rotating rollers are continuously provided inside the guide frame in the length direction,
the ball contains a rubber or a leather as a type of material that is filled with air and inflated, the ball does not come into contact with the vertical post due to the rotation of the shaft but slides and moves by being in contact with the roller.
